(19) United States
(12) Patent Application Publication
(10) Pub. No.: US 2002/0162008 A1
(43) Pub. Date: Oct. 31, 2002

(54) Method and system for controlling access to a telecommunication or internet system

(76) Inventor: Vincent Hill, Las Vegas, NV (US)

Correspondence Address: Anderson & Morishita, L.L.C., Suite 127, 3311 S. Rainbow, Las Vegas, NV, 89146, US

(21) Appl. No.: 09/765,893

(22) Filed: Jan. 18, 2001

Related U.S. Application Data
(60) Provisional application No. 60/178,581, filed on Jan. 28, 2000.

(51) Int. Cl. G06F 11/30

(52) U.S. Cl. 713/200

(57) ABSTRACT

A method and system for controlling access to a telecommunications or computer network, such as the Internet, includes a user or computer terminal communicating with a gateway server. The method begins with identifying the user or computer terminal requesting access to the network. A profile for the requester, including one or more access criteria, is accessed from a database. The gateway server determines whether the access criteria are met and access is allowed or denied. In an optional embodiment, the day and time of the request is compared to the predefined access periods. Optionally, the account billing information is additionally examined to determine whether the user has any time or credit remaining in the user's account. If the user's request has been made during one of the user's access periods and, optionally, the user has time or credit remaining in the user's account, access to the telecommunications or Internet system is allowed. Conversely, if the user has requested access outside the user's access period or, in an optional embodiment, if the user has no time, credit, or pre-paid money in the user's account, access is denied.

### RELATED APPLICATION DATA

The present application claims the priority of U.S. Provisional Application Serial No. 60/178,581 filed Jan. 28, 2000 by Applicant herein.

### FIELD OF THE INVENTION

The present invention relates to telecommunications and Internet systems. Specifically, the present invention is a method for controlling access to a telecommunications or computer network, including the Internet, by first determining a user's identity, then, based on the user's profile including access criteria, allowing or denying access to the network.

### BACKGROUND OF THE INVENTION

The Internet is a worldwide collection of interconnected computer networks that cooperatively form a seamless computer network. Users of the Internet access the Internet through a server. One method of connecting to a server, most often used by home users of the Internet, is connecting to an Internet service provider (“ISP”) server via a telephone line using a modem. An alternate method of connecting to the Internet, often used by business users of the Internet, is through a network server, or proxy server, shared by a small group of people.

A problem with Internet connectivity in particular, and with telecommunications in general, is the increasing demands on fixed bandwidth. Bandwidth is defined in the telecommunications and Internet art as the measure of the amount of data that can be transmitted through a system in a fixed amount of time. In digital devices, bandwidth is measured in units of bits per second (“bps”) or bytes per second.

It is also acknowledged in the telecommunications and Internet art that, because the speed of an electronic transmission is fixed, the measure of performance of a telecommunications system or ISP and, thus, the commodity sold by such telecommunications systems and ISPs, is bandwidth. Therefore, as the number of users and/or the amount of use of a telecommunications or Internet system increases, the demand on the bandwidth available increases. While this problem is universal in nature, it is of particular importance to small ISPs and ISPs in foreign countries which often do not have the financial means to invest in equipment to increase bandwidth to maintain pace with increased demand. Likewise, it can be important for businesses to control employees' access to the Internet to conserve bandwidth as well as prevent nonproductive or non-business use of the Internet. It can be seen, therefore, that there is a need in the art for controlling users' access to telecommunications systems or the Internet.

A related problem is that operating an ISP or telecommunications system requires investment in expensive equipment. However, the potential revenue stream is uncertain under the currently used flat-rate or hourly billing schemes in which service is provided and tracked and the user is billed for the access used. Prepaid access in which a user pays before being granted access to the system has been advanced as a possible solution to this problem. However, there has heretofore been no method for coupling prepaid access to a method for controlling a user's access to a telecommunications or Internet system.

In fact, there has heretofore been no method for effective prepaid Internet access. For example, a traveler accessing the Internet currently has to connect to his own ISP through the hotel or motel telephone system. The drawback of this system is that if the traveler's ISP has service at the traveler's location, the traveler must determine the telephone number to dial up the local server. Worse yet, if the traveler is not a subscriber to an national or international ISP, connecting to the user's home ISP will incur long distance charges. Thus, there is a need in the art for a method for selectively controlling access to the Internet for a group of users based on one or more predetermined criteria to enable the efficient utilization of bandwidth as well as enable a viable prepaid Internet access system.

### SUMMARY OF THE INVENTION

A method for controlling a user's access to a telecommunications network or computer network, such as the Internet, begins with a user requesting access to the system. In a telecommunications network, this may take the form of dialing a telephone number. In an Internet system, this may take the form of a computer terminal establishing a dial up connection to an Internet service provider (“ISP”) server or attempting to establish a connection through a network server. In such an embodiment, the computer terminal may have a software driver enabling automatic connection to the ISP. The user's identity is determined and a user profile stored on a database is accessed based on the user's identity. The user's identity may be determined by the user transmitting identifying information, such as a user name, password, person identification number (“PIN”), or the like. Alternatively, the user may be identified using an Automatic Number Identification (“ANI”) that identifies the user based on the telephone number from which the user or computer terminal is calling.

The user profile includes one or more criteria for determining the access allowed to the telecommunications or Internet system. For example, access periods and/or account billing information could be used to determine the access allowed to the telecommunications or Internet system. In the optional embodiment where access periods are used for the access criteria, the telecommunications or Internet system determines whether the access request has occurred during an allowable access period. Based on the time of the user's request and, optionally, the state of the user's account, access to the telecommunications or Internet system is allowed or denied.

In an alternative optional embodiment in which account status is used for the access criterion, the telecommunications or Internet system determines whether the user's account contains sufficient time or credit to allow access. Based on the status of the user's account at the time of the request, access to the telecommunications or Internet system is allowed or denied.

A system for providing the above method includes a computer terminal having a terminal communications device communicating with a gateway server having a server communications device and a first data structure. The first data structure stores a database of user profiles and programming instructions directing the method above. Specifically, the programming instructions include identifying a user or computer terminal in response to receiving a request for access; accessing a profile containing at least one access criteria at the database; determining whether the access criteria is satisfied; and allowing or denying access based on whether the criteria is satisfied or not satisfied, respectively. The system may further include programming instructions executed at the computer terminal storing the telephone number of the gateway server and information identifying a profile to allow prepaid access to the system.

It is an object of the present invention to provide a method for allocating bandwidth among users of a telecommunications or Internet system by controlling the users' access to the telecommunications or Internet system.

### BRIEF DESCRIPTION OF THE DRAWINGS

FIG. 1 is a flow chart of an embodiment of the method according to the present invention;

FIG. 2 is a flow chart of an embodiment of the method according to the present invention for dial-up Internet access;

FIG. 3 is a block diagram of an embodiment of the apparatus according to the present invention for dial-up Internet access;

FIG. 4 is a flow chart of an embodiment of the method according to the present invention for Internet access via a dedicated Internet connection;

FIG. 5 is a block diagram of an embodiment of the apparatus according to the present invention for Internet access via a dedicated Internet connection.

### DESCRIPTION

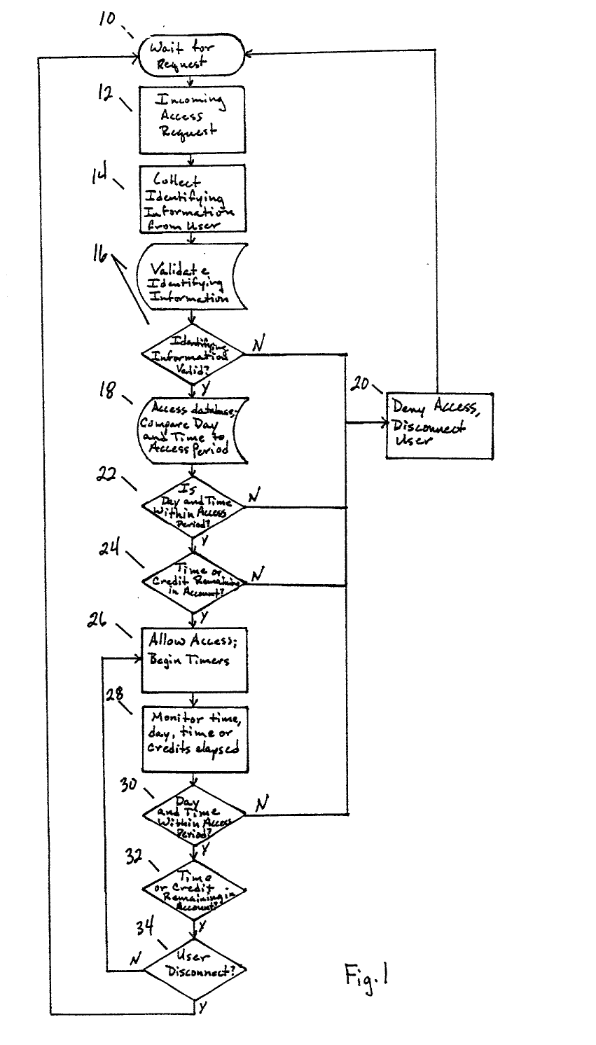

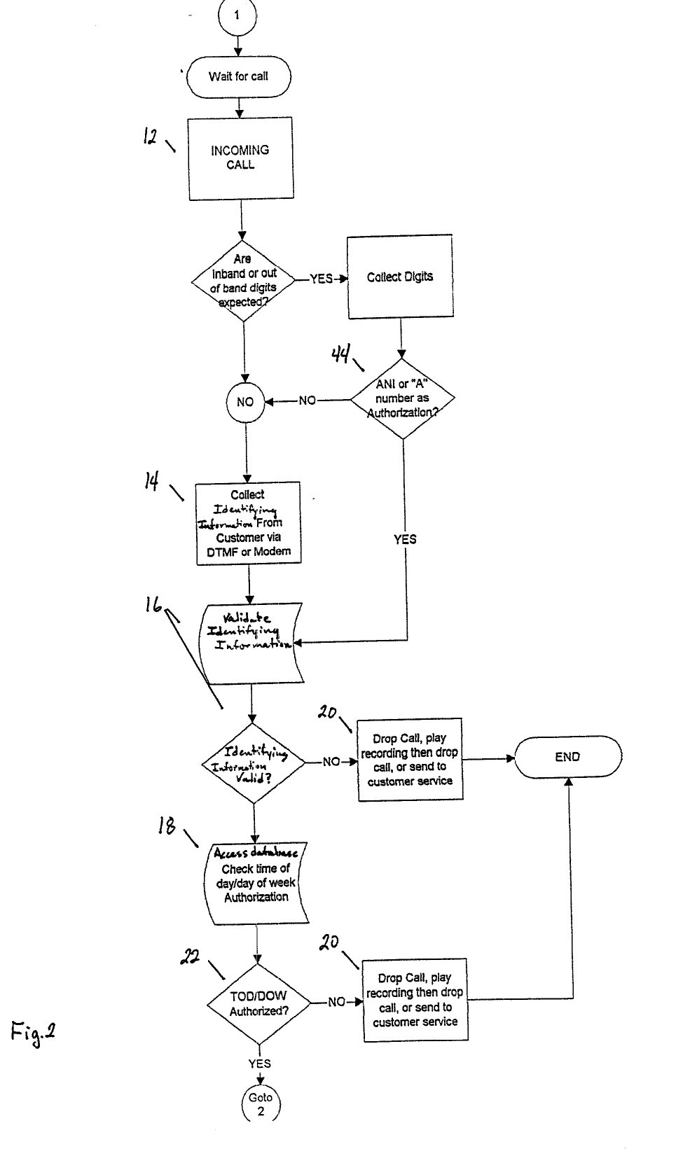

Reference is now made to the figures wherein like parts are referred to by like numerals throughout. With reference to FIGS. 1-5, the present invention is a method for controlling access to a telecommunications network or computer network 60, such as the Internet. Each of the optional embodiments shown in the figures are discussed in turn.

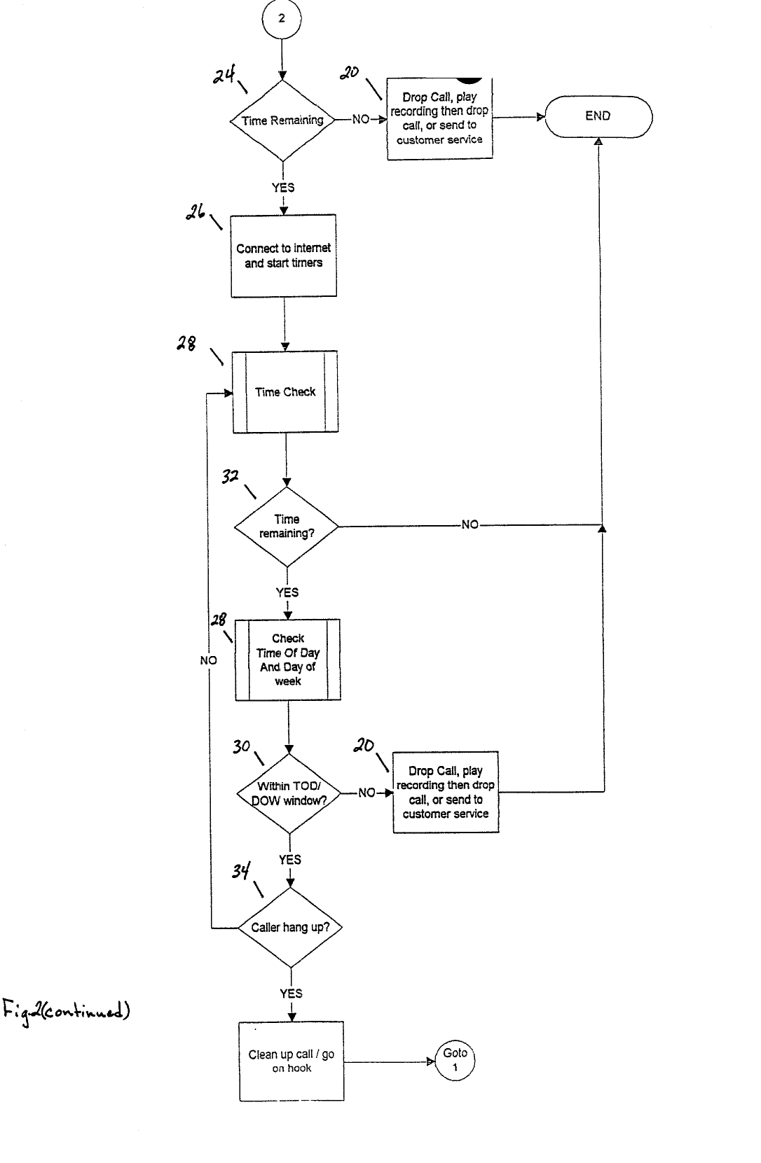

With reference to FIGS. 1-5, the present invention could be used to control a computer network's access to a computer network 60, specifically the Internet. As is well known in the art, there are many ways for a user or a computer terminal 51 to connect to the Internet 60. For example, a computer terminal 51 may use a modem to establish a dial-up connection over a telephone network to an Internet service provider (“ISP”) server 50 (shown in FIG. 1), access a dedicated connection 74 to the Internet 60 through a network server 70 (shown in FIG. 2), establish a connection via a cable modem or DSL modem to an ISP server 50, or the like (not shown). The examples given below should, therefore, not be considered limiting because the method described herein should be understood to apply to any type of Internet connection. The present method is optionally practiced by computer software 58 residing on an ISP server 50, on a network server 70, on a computer terminal 51, or the like.

As shown in FIG. 1, a first aspect of the present invention begins with the software 58 at the gateway server awaiting a request 10 for access to an Internet system 60. In an optional embodiment, a proxy server may reside between the gateway server and the computer terminal 51. The proxy server intercepts communications to the gateway server to filter requests and improve performance of the gateway server. When a computer terminal 51 requests access 12 to an Internet system 60, the computer terminal's identity is then determined by the gateway server receiving 14 identifying information from the computer terminal 51. A computer terminal 51 could be identified according the present method in many ways including the telephone number used to connect to the system using an automatic number identification (“ANI”) number 44, a unique or group password, a code entered using dual tone multi-frequency (“DTMF”) tones on a touch-tone telephone, or the like.

The computer terminal's identity is validated 16. If the computer terminal 51 is not a valid user, access is denied and the computer terminal 51 is disconnected 20. Once the computer terminal's identity is validated 16, the present method accesses 18 the computer terminal's profile at a database 62. The computer terminal's profile may be unique to the computer terminal 51 or may be common to a group of computer terminals 51. The computer terminal's profile includes one or more access criteria. For example, in one optional embodiment, access criteria include access periods defining the days of the week, i.e. access days, and the times of day, i.e. access times, that the computer terminal 51 will be allowed access to the computer network 60, such as the Internet. In an alternate or additional embodiment, the access criteria may include the status of the computer terminal's account balance such as time balance remaining. Time balance remaining could also be translated to prepaid monetary account balance or credit account balance by simple arithmetic as is well known in the art.

According to one optional embodiment shown in FIG. 1, the day of the week and time of day at the time of the request is determined and compared 22 to the access days and access times defined in the computer terminal's profile. In the embodiment of FIG. 1, for example, the day of the week at the time of the request is determined and compared to the access days defined in the access periods in the profile. If the request has not occurred during one of the predefined access days, access is denied and the call is disconnected 20.

If, conversely, the requested access is during one of the predefined access days, the time of day of the request is determined, such as with a chronometer communicating with the gateway server, and compared to the access times defined in the access periods in the profile. Again, if the request has not occurred during one of the predefined access times, access is denied and the call is disconnected 20. If, however, the computer terminal 51 has requested access during one of the predefined access times, the computer terminal 51 is allowed access 26 to the computer network 60, such as the Internet.

Additionally or alternatively, the computer network's account balance information may be stored in the profile and examined 24 before access is granted. In such an embodiment, the account balance information may include a time quantity balance, credit account balance, prepaid monetary account balance, or the like, remaining in the computer network's account. If the profile has time or credit remaining, or if the profile includes a positive prepaid monetary account balance, the computer terminal 51 is allowed access 26 to the Internet system 60. Conversely, if the profile has no credit or time remaining, the computer network is denied access and the call is disconnected 20 even if the request has occurred during one of the predefined access periods.

Once connected, one or more of the day, time, and account status may be monitored 28, such as with a chronometer, so that the user may be disconnected if use takes place outside the predefined access times 30 or after exhaustion of the time or credit remaining 32. For example, in one optional embodiment, the account balance is continuously debited by the gateway server and access is terminated when the account balance reaches zero. Otherwise, the connection to the Internet system 60 is maintained until the user disconnects 34.

In a further optional embodiment, the gateway server or proxy server may act as a content filter based on criteria stored in the user's account. That is, the gateway server or proxy server may intercept Internet transmissions based on predetermined criteria stored in the user's account once the connection to the Internet system 60 is established.

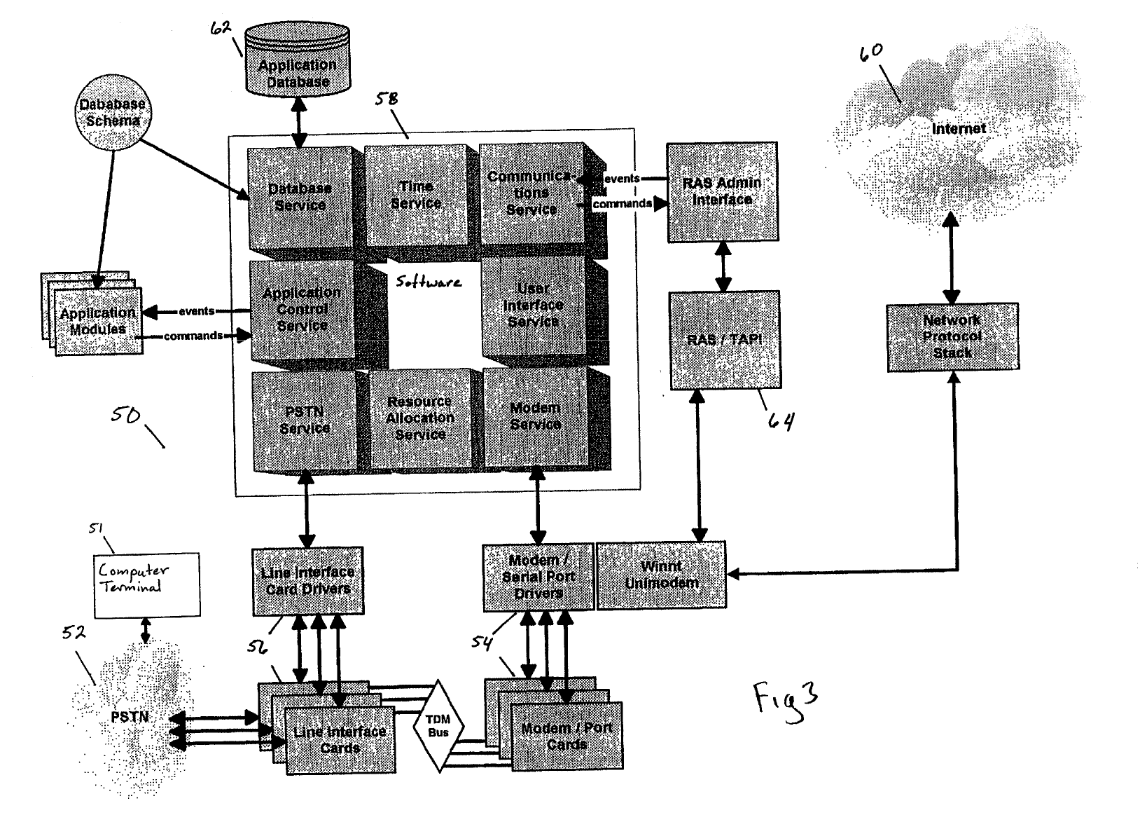

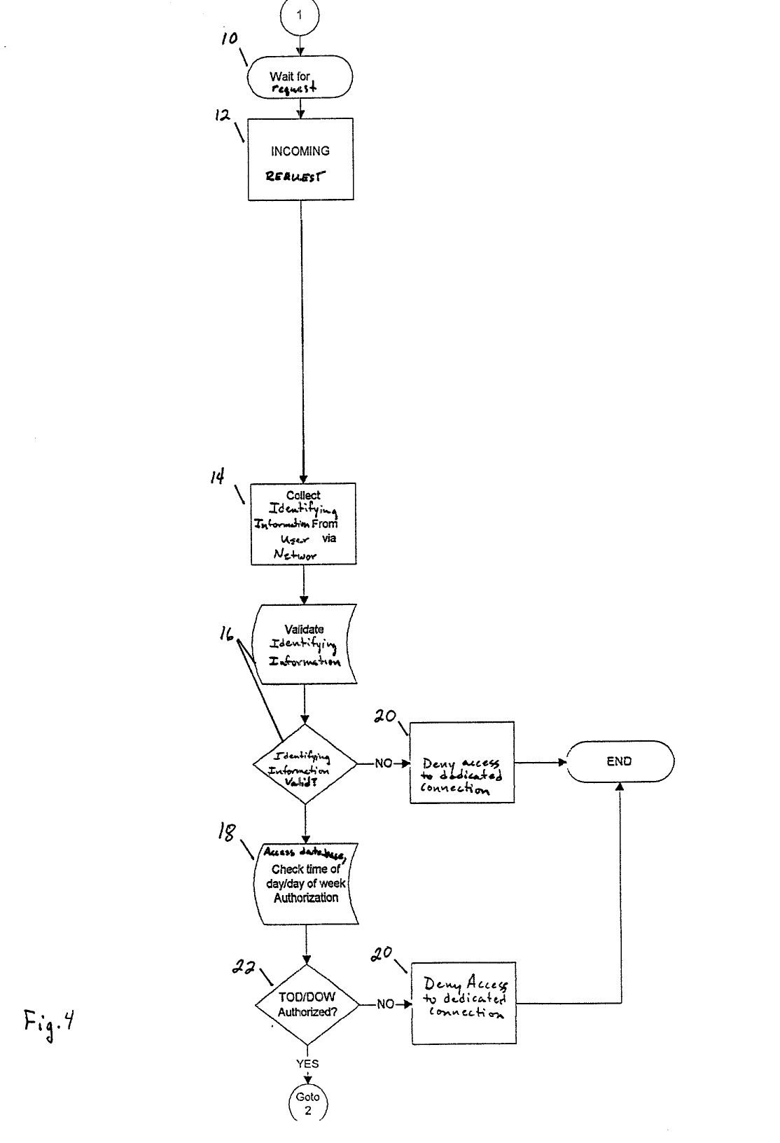

Two optional embodiments of the system of the present invention are set out with more specificity in FIGS. 2-5. Referring to FIGS. 2 and 3, the present method could be embodied in programming instructions 58, such as software, residing at the ISP server 50 that is reached through a dial-up connection between the user's computer and the modem 54 at the ISP server 50. In such an optional embodiment, the ISP server 50 may act as the gateway server. The ISP server includes a first data structure storing programming instructions 58 embodying the method of the present invention. The first data structure may be any data storage know in the art including RAM, ROM, EPROM, EAROM, magnetic storage media, optical storage media, or the like.

As described above, the ISP server 50 and, in an optional embodiment an associated proxy server, awaits 10 a dial-up call through a public switched telephone network (“PSTN”) 52. In an optional embodiment of the present invention, the computer terminal 51 includes a second data structure, such as the computer readable media at the computer terminal 51 storing programming instructions directing the computer terminal 51 or, alternatively or additionally, directing the operating system of the computer terminal 51. The second data structure could be any data storage known in the art including RAM, ROM, EPROM, EAROM, magnetic storage media, optical storage media, or the like. Generally, the second data structure may store programming instructions directing the computer terminal 51 to access the gateway server, transmit a request for Internet access to the gateway server, and transmit information identifying the computer terminal 51 to the ISP server 50.

For example, a self contained executable file stored on a removable computer readable media may be provided that contains a self contained executable file as well as the address (e.g. telephone number, Domain Name Server, Internet Protocol address, or the like) may be executed at the computer terminal 51 that causes the operating system to access the ISP server 50, transmit a request for access, and transmit a profile identifier in a single operation and without any installation. This enables the present method to be embodied on a single use removable computer media to be used for prepaid telecommunications or computer network access, including Internet access.

In one optional embodiment, for example, a compact disc could be provided that, when played or auto-played, directs the computer terminal 51 to execute a set of program instructions. In one optional embodiment, these program instructions are not installed on the computer terminal 51 but utilize program modules standard in the computer terminal's 51 operating system to establish a connection between the computer terminal and the ISP server 50. In an optional embodiment, the program instructions may additionally launch the computer terminal's default Internet browser and, in a further optional embodiment, direct the browser to a specific Internet address once the connection is established. In such an embodiment, pre-paid Internet access becomes possible because the compact disc could be purchased for a set amount. As described below, each compact disc could be associated with an account profile having a fixed period of computer network (e.g. Internet) access time available.

Once a request is received 12, programming instructions direct the ISP server 50 to identify the user by collecting 14 identifying information such as a profile identifier from the user using one of the methods described above using a modem 54 and a telephone line interface 56. For example, the ISP server 50 may validate 16 the user's identity the user using an ANI number 44 received from the PSTN, a password transmitted by the user, an access code transmitted using DTMF, an account number and password stored on the compact disc described above and transmitted by the computer terminal, or the like. Alternatively, the computer terminal 51 may transmit a profile identifier to the server 50. In such an alternate optional embodiment, the ISP server 50 may communicate with an associated Remote Identification Dial In User Service (“RADIUS”) system to authenticate the user's identity using a username and password transmitted by the user.

Based on the user's identity, the software 58 residing on the ISP server 50 accesses 18 a database 62 at the first data structure storing the user's profile and determines whether the access criteria are satisfied. It should be noted that the access criteria could include one or more criteria and that the criteria could include any criteria useful for controlling computer network access including time of day, day of week, time account balance, credit account balance, prepaid monetary account balance, or the like.

For example, in the optional embodiment of FIGS. 2 and 3, the ISP server 50 compares 22 the day and time of the dial-up call to the predefined access periods stored in the user's profile as described above. That is, the day is first compared to the access days and, if the day is within one of the user's access periods, the time is then compared to the access times.

As discussed above, additionally or alternatively, the computer terminal's account balance may be examined 24. For example, in the embodiment of FIGS. 2 and 3, the software 58 allows access 26 to the Internet 60 via a remote access server (“RAS”) 64 if the request has occurred during one of the predefined access periods and also has credit or time remaining in the user's account. Conversely, access may be denied 20 and the computer terminal 51 disconnected if the request has not occurred during an access period or if the user lacks sufficient time or credit in his account. If connected, the computer terminal's period of use is optionally timed 26 using a chronometer so that the time used may be continuously debited from the computer terminal's account balance. In an optional embodiment, the ISP server 50 transmits the account balance to the computer terminal 51.

Once connected, the time and day may optionally be monitored 28. If access is maintained outside one of the predefined access periods 30, the user may be disconnected 20. Likewise, the user's account balance may be monitored 28 and continuously debited or decremented during the period of access. This allows the ISP server 50 to disconnect 20 the user after exhaustion of the user's time or credit 32. Otherwise, the connection is maintained until the caller disconnects 34.

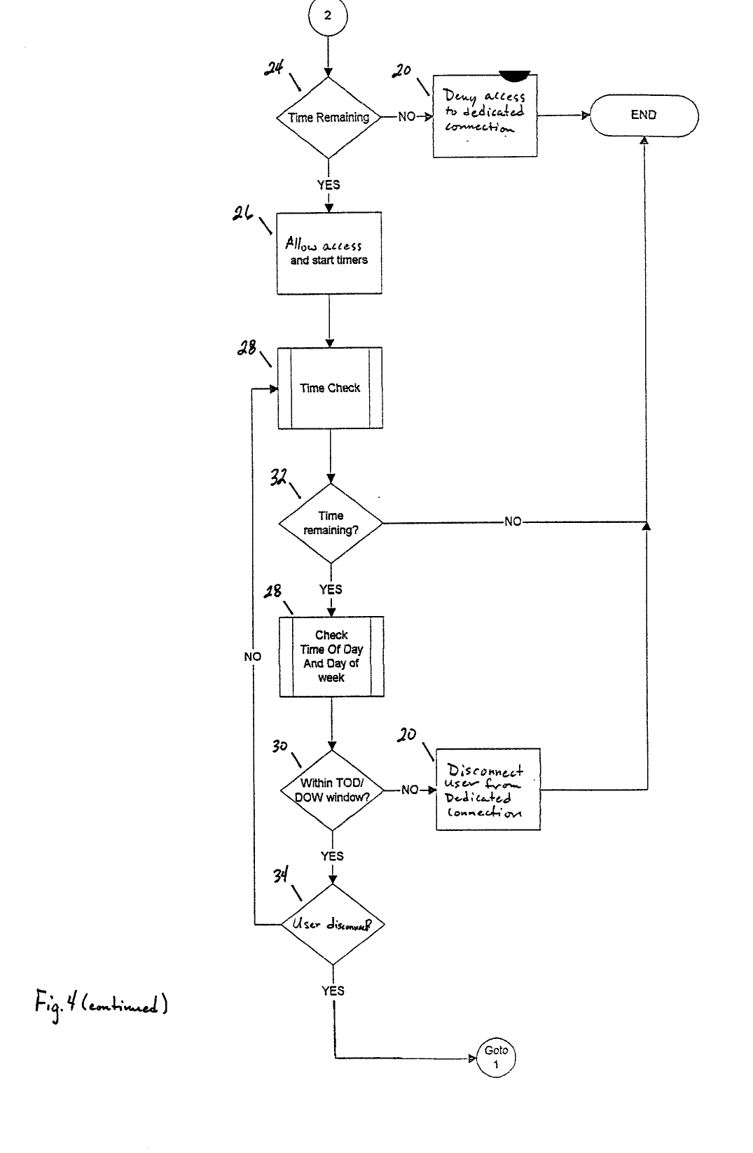

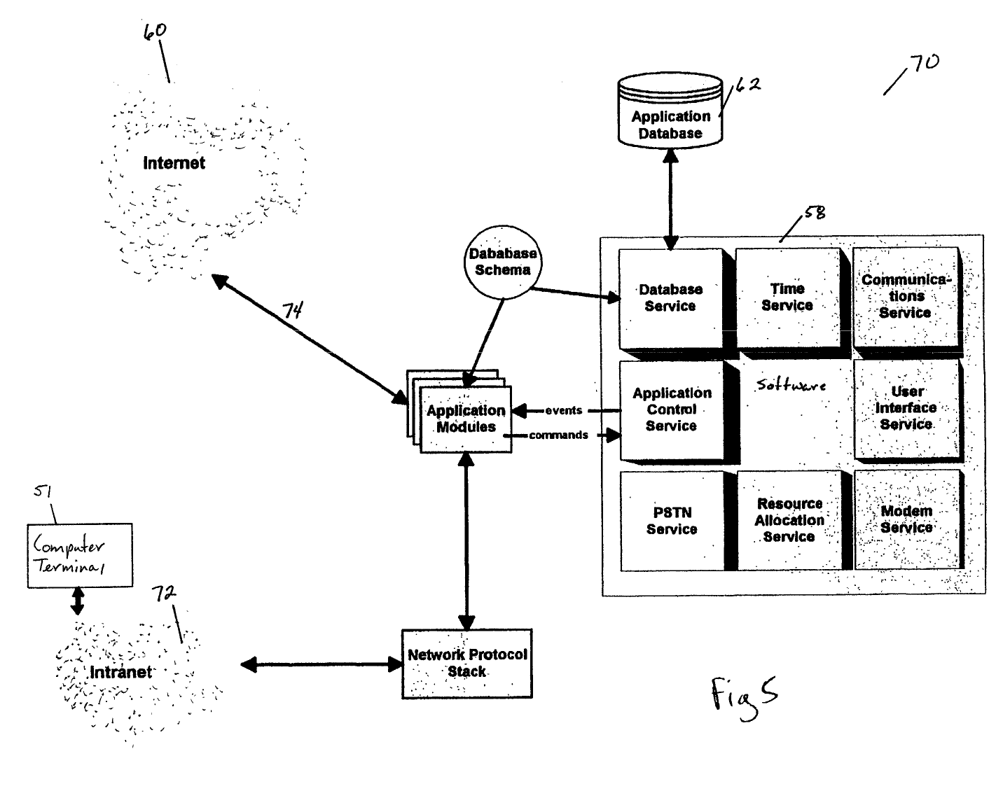

Similarly, FIGS. 4 and 5 illustrate an optional embodiment directed for use on a network server 70 in a local area network (“LAN”) or wide area network (“WAN”) environment, also referred to as an intranet system 72, in which dedicated access to the Internet is provided.

In such an embodiment, the software 58 optionally resides on the network server 70 and acts as a gateway to the server's dedicated connection 74 to the Internet 60. The software 58 awaits 10 a request to access the Internet 60. When a computer terminal 51 requests 12 access the Internet 60, the software 58 collects 14 identifying information about the computer terminal 51, such as with a password transmitted from the computer terminal 51 to the network server 70. As above, the software 58 validates 16 the computer terminal's identity and accesses 18 a database 62 storing the computer terminal's profile. The access criteria are examined and access is denied if the access criteria are not met. Conversely, access is allowed if the access criteria are met. For example, in the optional embodiment of FIG. 4, the day and time are compared 22 to the computer terminal's access periods and the computer terminal 51 is allowed access to the dedicated connection 74 to the Internet 60 if the day and time are within one of the computer terminal's 51 access periods.

The software 58 may optionally examine 24 the remaining account balance available in the profile if access is to be restricted to a fixed amount. The computer terminal 51 may be denied access 20 if the requested access 12 is outside the access periods in the profile or if an insufficient account balance is available in the profile. Once connected 26, the time and day may optionally be monitored 28. If access is maintained outside one of the predefined access periods 30 or after the account balance has been exhausted 32, the computer terminal 51 may be disconnected 20. Otherwise, the connection is maintained until the computer terminal 51 disconnects 34.

With reference to FIG. 1, in a second aspect of the present invention, the method may be used on a telecommunications system to control user access. For example, such control may be desirable for users utilizing prepaid telephone cards. In such an embodiment, the telecommunications system awaits 10 an incoming request. When a request is received 12, the software 58 identifies 14 a user such as by receiving a unique number using DTMF from the caller or the like. The software 58 validates 16 the user's identifying information, then accesses 18 a user profile. Again, as with the embodiments described above, the user profile may be unique or, optionally, be shared with a group. Based on the access criteria in the user's profile, the software either allows 26 or denies 20 access to the telecommunications system. For example, the access criteria may optionally include access periods 22 and, optionally, account balance 24. Thus, if the request is made during the user's access period as determined by comparing 22 the day to the access days and the time of day to the access times and, optionally, time or credit remaining in the user's account 24, access is granted 26. If, conversely, the request is made outside the user's access period 22 or, optionally, no time or credit remains in the user's account 24, access is denied 20.

The day and time may optionally be monitored 28 such that the user may be disconnected 20 if the user maintains the connection outside the access period 30. Likewise, the credit or time remaining may optionally be monitored 28 such that the user may be disconnected 20 if the user maintains the connection after exhausting the time or credit available 32. Otherwise, the connection is maintained until the user disconnects 34.

While certain embodiments of the present invention have been shown and described it is to be understood that the present invention is subject to many modifications and changes without departing from the spirit and scope of the claims presented herein.

I claim:

1. A method for controlling access of a user to a telecommunications network via a gateway server having a server communications device and a first data structure comprising:
the gateway server receiving a profile identifier;
the gateway server accessing a profile stored in a database at the first data structure based on the profile identifier, the profile containing at least one access criterion;
if all the access criteria are satisfied, the gateway server allowing the user access to the telecommunications network; and
if any access criteria are not satisfied, the gateway server denying the user access to the telecommunications network.

2. The method of claim 1 wherein at least one of said access criterion is the time of day.

3. The method of claim 1 wherein at least one of said access criterion is the day of the week.

4. The method of claim 1 wherein said profile additionally contains an account balance available to the user and the gateway server continuously decrements said account balance by the time elapsed during access to the telecommunications network.

5. In the method of claim 1 in which the user communicates to the gateway server via a public switched telephone network, the step of receiving a profile identifier comprising the gateway server receiving automatic number identification data from a public switched telephone network identifying the telephone number from which a user is connecting.

6. A method for controlling access of a computer terminal having a terminal communications device connected to telecommunications lines to a computer network via a gateway server having a first data structure and a server communications device accessible via telecommunications lines at a predetermined address, comprising:
providing computer readable media at said computer terminal, said readable media storing an address for accessing said gateway server;
providing a database at the first data structure storing at least one profile correlated to a profile identifier, said profile including an access criterion;
the computer terminal accessing said gateway server at the predetermined address via said telecommunications lines;
the gateway server receiving a profile identifier at said server communications device;
the gateway server accessing a profile associated with the profile identifier received;
the gateway server determining whether the access criterion is satisfied;
if all the access criterion in a profile associated with a requesting computer terminal are satisfied, the gateway server allowing the requesting computer terminal access to the computer network; and
if the access criterion in a profile associated with a requesting computer terminal are not satisfied, the gateway server denying the requesting computer terminal access to the computer network.

7. The method of claim 6 wherein at least one of said access criterion is the time of day.

8. The method of claim 6 wherein at least one of said access criterion is the day of the week.

9. The method of claim 6 wherein said profile additionally contains an account balance available to the computer terminal and the gateway server continuously decrements said account balance by the time elapsed during access to the computer network.

10. In the method of claim 6 in which at least one of the computer terminals communicates to the gateway server via a public switched telephone network, the step of receiving a profile identifier comprising the gateway server receiving automatic number identification data from a public switched telephone network identifying the telephone number from which a computer terminal is connecting.

11. A system for controlling access of a plurality of computer terminals to a computer network, comprising:
a gateway server having access to the computer network, said gateway server having a server communications device accessible via telecommunications lines at a predetermined address;
a computer terminal having a terminal communications device connected to said public communications lines;
computer readable media at said computer terminal, the computer readable media storing:
(a) an address for accessing said gateway server; and
(b) programming instructions directing said computer terminal to access said gateway server at the stored address via said telecommunications lines; and
a first data structure at the gateway server storing:
(a) a database storing at least one profile correlated to a profile identifier, said profile including an access criterion;
(b) programming instructions directing the receipt of a profile identifier at said server communications device;
(c) programming instructions directing the accessing of a profile identified by said profile identifier;
(d) programming instructions determining whether said access criterion is satisfied;
(e) programming instructions disconnecting the computer terminal if said access criterion is not satisfied; and
(f) programming instructions allowing the computer terminal computer network access if said access criterion is satisfied.

12. The system of claim 11 wherein at least one of said access criterion is the time of day.

13. The system of claim 11 wherein at least one of said access criterion is the day of the week.

14. The system of claim 11 wherein said profile additionally contains an account balance available to the user and the gateway server continuously decrements said account balance by the time elapsed during access to the computer network.

15. In the system of claim 14 in which said computer terminal includes a display, the system further comprising programming instructions stored at the first data structure directing the gateway server to transmit data representing the account balance to the computer terminal for display thereat.

16. The system of claim 11 wherein said telecommunications lines include a public switched telephone network and said profile identifier includes automatic number identification data from said public switched telephone network identifying the telephone number from which a computer terminal is connecting.

17. A method for controlling access of a computer terminal having a terminal communications device connected to telecommunications lines to a computer network via a gateway server having a first data structure and a server communications device accessible via telecommunications lines at a predetermined address, comprising:
providing computer readable media at said computer terminal, said readable media storing an address for accessing said gateway server;
providing a database at the first data structure storing at least one profile correlated to a profile identifier, said profile including an access time period;
the computer terminal accessing said gateway server at the predetermined address via said telecommunications lines;
the gateway server receiving a profile identifier at said server communications device;
providing a chronometer at the gateway server and determining the time of day of the computer terminal access;
the gateway server accessing a profile associated with the profile identifier received;
the gateway server determining whether the computer terminal access has occurred during the access time period;
if the computer terminal access has occurred during the access time period in the profile, the gateway server allowing the requesting computer terminal access to the computer network; and
if the computer terminal access has not occurred during the access time period in the profile, the gateway server denying the requesting computer terminal access to the computer network.

18. In the method of claim 17 in which at least one of the computer terminals communicates to the gateway server via a public switched telephone network, the step of receiving information identifying the computer terminal comprising the gateway server receiving automatic number identification data from a public switched telephone network identifying the telephone number from which a computer terminal is requesting.

19. A system for controlling access of a plurality of computer terminals to a computer network, comprising:
a gateway server having access to the computer network, said gateway server having a server communications device accessible via telecommunications lines at a predetermined address;
a chronometer communicating with said gateway server;
a computer terminal having a terminal communications device connected to said public communications lines;
computer readable media at said computer terminal, the computer readable media storing:
(a) an address for accessing said gateway server; and
(b) programming instructions directing said computer terminal to access said gateway server at the stored address via said telecommunications lines; and
a first data structure at the gateway server storing:
(a) a database storing at least one profile correlated to a profile identifier, said profile including an access time period;
(b) programming instructions directing the receipt of a profile identifier at said server communications device;
(c) programming instructions directing communication with said chronometer to determine the time of day of the computer terminal access;
(d) programming instructions directing the accessing of a profile identified by said profile identifier;
(e) programming instructions determining whether the profile identifier was received during the access time period;
(f) programming instructions disconnecting the computer terminal if computer terminal access has occurred during the access time period; and
(g) programming instructions allowing the computer terminal computer network access if the computer terminal access has not occurred during the access time period.

20. In the system of claim 19 wherein said telecommunications lines include a public switched telephone network and said profile identifier includes automatic number identification data from said public switched telephone network identifying the telephone number from which a computer terminal is connecting.

21. A method for controlling access of a computer terminal having a terminal communications device connected to telecommunications lines to a computer network via a gateway server having a first data structure and a server communications device accessible via telecommunications lines at a predetermined address, comprising:
providing computer readable media at said computer terminal, said readable media storing an address for accessing said gateway server;
providing a database at the first data structure storing at least one profile correlated to a profile identifier, said profile including an account balance;
the computer terminal accessing said gateway server at the predetermined address via said telecommunications lines;
the gateway server receiving a profile identifier at said server communications device;
the gateway server accessing a profile associated with the profile identifier received;
the gateway server determining whether a balance remains in the account in the accessed profile;
if an account balance remains in the profile, the gateway server allowing the requesting computer terminal access to the computer network; and
if no account balance remains in the profile, the gateway server denying the requesting computer terminal access to the computer network.

22. In the method of claim 21 in which said computer terminal includes a display, the method further comprising the gateway server transmitting data to the computer terminal representing the account balance for display thereat.

23. In the method of claim 21 in which at least one of the computer terminals communicates to the gateway server via a public switched telephone network, the step of receiving information identifying the computer terminal comprising the gateway server receiving automatic number identification data from a public switched telephone network identifying the telephone number from which a computer terminal is requesting.

24. The method of claim 21 further comprising the gateway server timing the computer network access and continuously decrementing said account balance by the time elapsed during access to the computer network.

25. A system for controlling access of a plurality of computer terminals to a computer network, comprising:
a gateway server having access to the computer network, said gateway server having a server communications device accessible via telecommunications lines at a predetermined address;
a computer terminal having a terminal communications device connected to said public communications lines;
computer readable media at said computer terminal, the computer readable media storing:
(a) an address for accessing said gateway server; and
(b) programming instructions directing said computer terminal to access said gateway server at the stored address via said telecommunications lines; and
a first data structure at the gateway server storing:
(a) a database storing at least one profile correlated to a profile identifier, said profile including an account balance;
(b) programming instructions directing the receipt of a profile identifier at said server communications device;
(c) programming instructions directing the accessing of a profile identified by said profile identifier;
(d) programming instructions determining whether a balance remains in the account in the accessed profile;
(e) programming instructions disconnecting the computer terminal if no account balance remains; and
(f) programming instructions allowing the computer terminal computer network access if an account balance remains.

26. In the system of claim 25 in which said computer terminal includes a display, the system further comprising programming instructions stored at the first data structure directing the gateway server to transmit data representing the account balance to the computer terminal for display thereat.

27. In the system of claim 25 in which at least one of the computer terminals communicates to the gateway server via a public switched telephone network, the programming instructions directing receipt of information a computer terminal comprising the gateway server receiving automatic number identification data from the public switched telephone network identifying the telephone number from which the computer terminal is requesting.

28. A method for controlling access of a computer terminal, said computer terminal operating under the direction of an operating system, having a terminal communications device connected to public telecommunications lines to a computer network via a gateway server having a first data structure and a server communications device accessible via public telecommunications lines at a predetermined address, comprising:
providing removable computer readable media at said computer terminal, said readable media storing an address for accessing said gateway server and a profile identifier;
providing a database at the first data structure storing at least one profile correlated to a profile identifier, said profile including an access criterion;
programming instructions at the removable computer readable media directing the operating system at the computer terminal to access said gateway server at the stored address via said telecommunications lines without storing said programming instructions at the computer terminal;
programming instructions at the removable computer readable media directing the operating system at the computer terminal to transmit the stored profile identifier to the gateway server without storing said programming instructions at the computer terminal;
the gateway server accessing a profile associated with the profile identifier received;
the gateway server determining whether the access criterion in the profile is satisfied;
if said access criterion is not satisfied, the gateway server denying the requesting computer terminal access to the Internet;
if said access criterion is satisfied, the gateway server allowing the requesting computer terminal access to the Internet; and
monitoring said Internet access and disconnecting said computer terminal if at any time during the Internet access said access criterion is not satisfied.

29. The method of claim 28 wherein the access criterion is the account balance of time.

30. The method of claim 28 wherein the profile further includes predefined content criteria, the method further comprising monitoring the Internet access and intercepting any Internet transmissions defined in the content criteria.

31. The method of claim 28 wherein said computer terminal utilizes an Internet browser to receive Internet transmissions, the method further comprising programming instructions at said removable computer readable media directing the launch of said Internet browser and directing the Internet browser to a predetermined Internet address.

32. A system for controlling a user's access to the Internet, comprising:
a gateway server having access to the Internet, said gateway server having a server communications device accessible via public telecommunications lines at a predetermined address;
a computer terminal having a terminal communications device connected to said public telecommunications lines, said computer terminal operating under the direction of an operating system;
removable computer readable media at said computer terminal, the computer readable media storing:
(a) an address for accessing said gateway server;
(b) programming instructions directing said operating system to access said gateway server at the stored address via said public telecommunications lines without storing said programming instructions at said computer terminal;
(c) a profile identifier; and
(d) programming instructions directing the transmission of said profile identifier to said gateway server without storing said programming instructions at said computer terminal; and
a first data structure at said gateway server storing:
(a) a database storing at least one profile correlated to a profile identifier, said profile including an access criterion;
(b) programming instructions directing the receipt of a profile identifier at said server communications device and the access of a profile identified by said profile identifier;
(c) programming instructions determining whether said access criterion is satisfied;
(d) programming instructions disconnecting said computer terminal if said access criterion is not satisfied;
(e) programming instructions allowing the computer terminal Internet access if said access criterion is satisfied; and
(f) programming instructions monitoring said Internet access and disconnecting said computer terminal if at any time during the Internet access said access criterion is not satisfied.

33. The system of claim 32 wherein the access criterion is the account balance of time.

34. The system of claim 32 wherein the profile further includes predefined content criteria, the system further comprising programming instructions at the gateway server directing the gateway server to monitor the Internet access and intercept any Internet transmissions defined in the content criteria.

35. The system of claim 32 further comprising:
Internet browser at said computer terminal receiving Internet transmissions; and
programming instructions at said removable computer readable media directing the launch of said Internet browser and directing the Internet browser to a predetermined Internet address after Internet access is allowed by said gateway server.
